(19) United States
(12) Patent Application Publication
(10) Pub. No.: US 2005/0118325 A1
(43) Pub. Date: Jun. 2, 2005

(54) Starch n-alkenyl succinate as texturizing agent for uht treated products

(75) Inventors: Nils Cornelis Adrianus Petrus Sips, VC Roermond (NL); Bernd Wolfgang Kettlitz, Bonheiden (BE)

Correspondence Address: FITCH, EVEN, TABIN & FLANNERY, P. O. BOX 65973, WASHINGTON, DC, 20035, US

(73) Assignee: Cerestar Holding B.V., LA Sas van Gent (NL)

(21) Appl. No.: 10/502,082

(22) PCT Filed: Jan. 23, 2003
(86) PCT No.: PCT/EP03/00668

(30) Foreign Application Priority Data
Jan. 24, 2002 (GB) 0201552.7

(51) Int. Cl. A23G 3/00

(52) U.S. Cl. 426/658

(57) ABSTRACT

The present inventions relates to UHT-treated products containing a strach n-alkenyl succinate as texturizing agent, whereby such products have a low viscosity after UHT-treatment, but develope their full viscosity after a second treatment. Starch n-octenyl succinate can be used as well as a combined texturizing agent and partial egg yolk replacement in UHT-treated products. A process for preparing these products is provided.

### TECHNICAL FIELD

The present invention relates to UHT-treated products comprising starch n-alkenyl succinate wherein starch n-alkenyl succinate is texturising agent and viscosity of UHT-treated product is significant lower than viscosity of re-heated UHT-treated product.

### BACKGROUND OF THE INVENTION

Modified starches such as starch octenyl succinate have been applied in different applications.

EP 0 537 126 relates to manufacture of low calorie margarine having an extra low fat content. An acid-hydrolysed starch further stabilised with for example octenylic-succinylic groups can be used to completely eliminate the need of using a monoglyceride emulsifier.

U.S. Pat. No. 6,077,558 relates to an alternative emulsifying system for elemental diet compositions and said emulsifying system is comprising octenyl succinic anhydride modified starch and an acetylated monoglyceride emulsifier.

U.S. Pat. No. 4,414,238 is concerned with a nutritionally balanced food composition and specifically with ready-to-use liquid elemental diet which is non-browning at elevated temperature. The liquid elemental diet composition comprises an aqueous combination of carbohydrate, amino acids and lipid components. Stability of said composition is enhanced by the inclusion of a modified starch, e.g waxy maize starch which has been modified with succinic anhydride.

U.S. Pat. No. 5,919,512 relates to beverages that have stable flavour emulsions and/or cloud emulsions in the presence of polyphosphate containing preservative systems. Suitable emulsifiers include gum acacia, modified food starches (e.g. alkenylsuccinate modified food starch).

EP 1 008 306 relates to polysaccharides when can reduce viscosity resulting from psyllium. Modified starches, which give excellent psyllium viscosity-reducing effect, may include oxidised tapioca starch, oxidised potato starch, acid-treated gelatinised potato starch, waxy corn starch octenyl succinate and acid-treated hydroxypropyl etherified tapioca starch.

EP 0 966 889 relates to powder compositions and emulsion compositions useful to produce nutritious vitamin and mineral supplemented beverages which contain vitamin E and other fat soluble vitamins. Starch treated with cyclic dicarboxylic acid such as succinic anhydrides can be applied as good emulsifier.

EP 1 057 416 provides a soluble isoflavone composition which has high solubility in water, in which stable over a long time period and can be incorporated into various kinds of foods without changing characteristic properties peculiar thereto. There is provided a soluble isoflavone composition which comprises isoflavone and anhydrous or water-containing propylene glycol and/or ocetenyl succinate-treated starch as solubilising agent.

The last decades eating habits have put more stress upon availability of convenience food. Thermal processes such as UHT (ultra-high-temperature) treatment have grown in importance for preparing convenience food.

WO 94/0437 describes a bakery custard comprising a UHT-stable starch. Said UHT-stable starch is either acetylated distarch adipate or hydroxypropyl distarch phosphate.

Currently there exists a need for a UHT-treated product wherein the texturising agent develops no viscosity during UHT treatment, but full viscosity is developed during a second heating treatment, while afterwards there is no significant change in this viscosity.

The current invention provides such a product.

### SUMMARY OF THE INVENTION

The present invention relates to a UHT-treated product comprising starch n-alkenyl succinate wherein starch n-alkenyl succinate is applied as texturising agent and said UHT-treated product has after UHT-treatment a viscosity which is between 0.10 to 0.50 times the viscosity obtainable after re-heating of said UHT-treated product, preferably between 0.15 to 0.40 times the viscosity obtainable after re-heating.

The present invention further relates to a UHT-treated product comprising starch n-alkenyl succinate wherein the alkenyl succinate is from C₆ to C₁₆ succinate, preferably n-octenyl succinate. The starch alkenyl succinate is undextrinised, dextrinised, cooked-up, pregelatinised, enzyme-treated, or stabilised starch alkenyl succinate and/or mixtures thereof.

The present invention further relates to a UHT-treated product comprising stabilised starch alkenyl succinate as texturising agent and said UHT-treated product has after UHT-treatment a viscosity which is between 0.15 to 0.35 times the viscosity obtainable after re-heating of said UHT-treated product.

The present invention relates to a UHT-treated product selected from the group consisting of UHT-treated sauces, soups, liquid desserts, dressings and fillings.

Furthermore, the present invention relates to a UHT-treated white sauce comprising from 2 to 5% w/w starch n-alkenyl succinate, preferably from 3 to 4% w/w starch n-alkenyl succinate, and its viscosity after UHT treatment is below 1500 MPa.s, preferably below 1000 mPa.s, whereas after re-heating the UHT-treated product, the viscosity increases above 2000 mPa.s, preferably above 2200 mPa.s.

The present invention further relates to a process for preparing UHT-treated product comprising starch n-alkenyl succinate and said process is comprising the following steps:
a) Preparing the mix of the ingredients comprising starch n-alkenyl succinate,
b) Preheating said mix to a temperature higher than 50° C., preferably to a temperature up to 75° C.,
c) Homogenising said preheated mix at a pressure of more than 20 bar,
d) Treating the mix by UHT at a temperature higher than 120° C.,
e) Cooling the UHT-treated product.

The present invention further relates to a process wherein the starch n-alkenyl succinate is stabilised starch alkenyl succinate.

The present invention relates to a process wherein the UHT-treated product of step e) is re-heated to a temperature higher than 80° C., preferably higher than 90° C.

The current invention further relates to the use of starch n-alkenyl succinate as texturising agent in UHT-treated product and especially to the use of stabilised starch alkenyl succinate as texturising agent in UHT-treated products.

The present invention further relates to the use of starch n-alkenyl succinate in UHT-treated products and viscosity of said UHT-treated product is between 0.10 to 0.50 times the viscosity obtainable after re-heating of said UHT-treated product.

The current invention further relates to the use in UHT-treated products selected from the group consisting of sauces, soups, liquid desserts, dressings and fillings.

Furthermore, the present invention describes the use of starch n-alkenyl succinate as texturising agent in UHT-treated product wherein egg yolk content of said product is reduced with at least 50% by adding starch n-alkenyl succinate, preferably stabilised starch alkenyl succinate.

### DETAILED DESCRIPTION OF THE INVENTION

The present invention relates to a UHT-treated product comprising starch n-alkenyl succinate wherein starch n-alkenyl succinate is applied as texturising agent and said UHT-treated product has after UHT-treatment a viscosity which is between 0.10 to 0.50 times the viscosity obtainable after re-heating of said UHT-treated product, preferably between 0.15 to 0.40 times the viscosity obtainable after re-heating.

The starch used in the present invention may be from a variety of sources such as corn, waxy maize, potato, pea, rice, wheat, cassava (tapioca), sorghum, and the like, preferably waxy maize and tapioca.

The starch n-alkenyl succinate is characterised by the chain length of the alkenyl-group and by the substitution degree of n-alkenyl succinate on starch. Alkenyl can be from C₆ to C₁₆, preferably C₈(octenyl), and the substitution degree varies between 0.2 to 3%, preferably between 0.5 to 2.5%. This substitution degree is determined by HPLC.

The starch alkenyl succinate is undextrinised, dextrinised, cooked-up or pregelatinised, enzyme-treated or stabilised and/or mixtures thereof.

For obtaining the stabilised starch n-alkenyl succinate, the starch n-alkenyl succinate can be treated with active chlorine and can be prepared according to the process described in EP 0811633.

The present invention further relates to a UHT-treated product wherein the starch n-alkenyl succinate is starch n-octenyl succinate and in a specific example starch is treated with n-octenyl succinic anhydride followed by the treatment with hypochlorite in an amount equivalent to 100 to 2000 ppm active chlorine and a stabilised starch n-octenyl succinate is obtained.

Ultra-high-temperature (UHT) treatment enables sterility to be achieved with minimal chemical change to the product.

Two methods of heat treatment are principally used in UHT processing: indirect heating, using hot water or steam, and direct heating, using steam.

Indirect heating systems are usually based on plate heat exchangers, tubular heat exchangers or scraped-surface heat exchangers.

Direct heat-exchangers use steam for product sterilisation. With the injection or steam-into-product system, a steam injector is used to introduce bubbles of steam into the product flow. The steam, at a higher temperature than the product, condenses to raise the product temperature to that required for sterilisation.

An alternative to the injection system is the infusion or product-into-steam system. This is based on a steam pressure vessel with an infuser at the top and a conical base. Product passes through the steam atmosphere into the collecting cone. As the product falls, the temperature is raised through the contact with the steam. The heated product is then pumped through the holding tube into an expansion vessel for water removal and cooling. The type and lay-out of a UHT process will vary according to the products and requirements.

Surprisingly it is found by the current invention that products comprising starch n-alkenyl succinate, after UHT-treatment still have low viscosity. After UHT-treatment the viscosity is only between 0.10 to 0.50 times the viscosity obtainable after re-heating of said UHT-treated product. During the re-heating step, full viscosity of the product is developed and said viscosity remains stable after cooling and during storage of the product.

In particular, the current invention relates to a UHT-treated product which is comprising a stabilised starch n-alkenyl succinate as texturising agent and said UHT-treated product has after UHT-treatment a viscosity which is between 0.15 to 0.35 times the viscosity obtainable after re-heating of said UHT-treated product.

In comparison, currently existing starch-based products used for UHT-treatment, such as acetylated distarch adipate or hydroxypropyl distarch phosphate, develop directly full viscosity during UHT-treatment and said viscosity increases further during the second heating step and during storage the viscosity is not stable.

The current invention discloses UHT-treated products selected from the group consisting of UHT-treated sauces, soups, liquid desserts, dressings and fillings.

In particular, the present invention relates to a UHT-treated white sauce comprising from 2 to 5% w/w starch n-alkenyl succinate, preferably from 3 to 4% w/w starch n-alkenyl succinate, and its viscosity after UHT treatment is below 1500 mPa.s, preferably below 1000 mPa.s, whereas during re-heating viscosity increases above 2000 mPa.s, preferably above 2200 mPa.s.

It is very important that during the heating of the UHT-treatment the texturising agent is not developing viscosity and that the starch granule is not damaged during this heating and shear process. This is a very striking difference with other starch based texturising agents for UHT-products. The comparative example clearly demonstrates that hydroxypropylated distarch phosphate (tapioca based) already has significant increase of viscosity during UHT treatment, whereas UHT-treated products comprising starch n-octenyl succinate as texturising agent have low viscosity after UHT-treatment (example 1). When heating the product for a second time, then full viscosity is developed and after cooling and during storage there is no post-thickening effect observed for the UHT-treated product comprising starch n-octenyl succinate.

In fact, the current invention allows preparing UHT-treated products which are still liquid after said treatment, and develop only during a second heating step full viscosity. In particular, the viscosity of the UHT-treated product after UHT-treatment and viscosity after re-heating differs at least with 1800 mPa.s, and values of up to 2900 mPa.s difference are observed.

The present invention further relates to a process for preparing UHT-treated product comprising starch n-alkenyl succinate and said process is comprising the following steps:
a) Preparing the mix of the ingredients comprising starch n-alkenyl succinate,
b) Preheating said mix to a temperature higher than 50° C., preferably to a temperature up to 75° C.,
c) Homogenising said preheated mix at a pressure higher than 20 bar,
d) Treating the mix by UHT at a temperature higher than 120° C.,
e) Cooling the UHT-treated product.

The process steps c) and d) might occur either in sequence or simultaneously.

This latter treatment of step d) only lasts for a few seconds.

The process can be based on direct or indirect heating. Whichever method is used, the process is broadly the same, with heat treatment being followed by aseptic storage and aseptic packing of the product.

The current invention further relates to the use of starch n-alkenyl succinate as texturising agent in UHT-treated product and in particular to the use of stabilised starch n-alkenyl succinate as texturising agent in UHT-treated products. These UHT-treated products are selected from the group consisting of sauces, soups, liquid desserts, dressings and fillings. Applying starch n-alkenyl succinate, especially starch n-octenyl succinate and more preferably stabilised starch n-octenyl succinate as texturising agents in UHT-treated products gives products with low viscosity after the UHT process and full viscosity is developed when re-heated, while no post-thickening during storage is occurring. Such a post-thickening effect is observed with the products currently in use for UHT-treatment (see comparative example). These existing products also lack the advantage of the current invention that after UHT-treatment the products still have low viscosity. In fact, the UHT-treated products of the current invention are characterised in that the texturising agent gives after UHT-treatment a viscosity which is only between 0.10 to 0.50 times the viscosity obtainable after re-heating of the UHT-treated product.

The current invention especially relates to the use of starch n-alkenyl succinate in UHT-treated products wherein at least 50% of egg yolk content is reduced by adding starch n-alkenyl succinate, preferably stabilised starch alkenyl succinate. Example 1 trial T2 clearly demonstrates that the egg yolk content of a product with normal egg yolk-content of 1.5% can be reduced to 0.75% by having starch n-octenyl succinate present in the product. Said product has acceptable texture and taste, and is comparable with the product containing normal egg content levels. By applying starch n-octenyl succinate as texturising agent in UHT-treated products, it partially can replace egg yolk in the finished product and consequently the cholesterol content is significant reduced.

The UHT-treated product of the current invention has the following advantages:
Low viscosity during UHT-heating, i.e. the product remains very liquid and there is no thickening during UHT treatment
Starch granule is not damaged during this heat treatment and shear treatment at high temperature
Thickening, i.e development of viscosity is obtained in a second heating step
Full viscosity remains stable during cooling and storage and there is no post-thickening effect.
Lower cholesterol content

The invention is illustrated by way of the following example.

Example 1 demonstrates that UHT-treated white sauce comprising starch n-octenyl succinate has low viscosity after said treatment, but viscosity is developed in a second heating step. Additionally it is demonstrated that similar results are obtainable when starch n-octenyl succinate is applied as texturising agent and as replacement for 50% of egg yolk content in UHT-treated white sauce.

The comparative example demonstrates that hydroxypropylated tapioca diphosphate already during UHT-treatment develops its viscosity and that during second heating step viscosity is increased further and post-thickening effect is observed.

### EXAMPLE 1

UHT-treated white sauce was prepared by applying the following recipe.

Recipe:

| Ingredients (percentage) | T1 | T2 - reduced egg content |
|---|---|---|
| Soya oil | 10 | 10 |
| Skimmed milk | 4 | 4 |
| Egg yolk | 1.5 | 0.75 |
| | | (=50% of egg yolk) |
| nOSA highly stabilised | 3 | 4 |
| tapioca starch | | |
| Water | 81.5 | 81.5 |

nOSA highly stabilised tapioca starch is obtainable from Cerestar.

The following UHT-treatment (APV pilot plant) was applied:
Preheating: 75° C.
Homogenisation: 25 bar
Heating: 138-140° C. for 10 sec (tubular system)
Cooling: max.

The second heating was performed with Janke & Kunkel equipment and products were heated up to 95° C. for 1 minute.

The products were characterised by their Brookfield viscosity (cyl. Spindle at 20 rpm and 20° C.).

The obtained results are displayed in Table 1.

TABLE 1

| Brookfield viscosity (in mPa · s) | T1 | T2 |
|---|---|---|
| 1 day after UHT-treatment | | |
| Before re-heating | 600 | 1300 |
| After re-heating | 2400 | 4200 |
| 1 week after UHT-treatment | | |
| Before re-heating | 700 | 1300 |
| After re-heating | 2500 | 4000 |
| 1 month after UHT-treatment | | |
| Before re-heating | 500 | 1300 |
| After re-heating | 2900 | 4400 |
| 3 months after UHT-treatment | | |
| Before re-heating | 700 | 1700 |
| After re-heating | 3600 | 4900 |

The products have low viscosity after UHT-treatment and high viscosity after second heating step. This is also applicable for products with reduced egg yolk content (see T2).

### COMPARATIVE EXAMPLE

UHT-treated white sauce was prepared by applying hydroxypropylated tapioca diphosphate (C CreamTex 75705 obtained from Cerestar) and by applying the following recipe:

Recipe:

| Ingredients (percentage) | Reference |
|---|---|
| Soya oil | 10 |
| Skimmed milk | 4 |
| Egg yolk | 1.5 |
| C CreamTex 75705 | 3 |
| (Cerestar) | |
| Water | 81.5 |

The product was treated according to the parameters of example 1. The obtained Brookfield viscosities are given in Table 2.

TABLE 2

| Brookfield viscosity (in mPa · s) | Reference |
|---|---|
| 1 day after UHT-treatment | |
| Before re-heating | 4000 |
| After re-heating | 4800 |
| 1 week after UHT-treatment | |
| Before re-heating | 3900 |
| After re-heating | 4800 |
| 1 month after UHT-treatment | |
| Before re-heating | 4500 |
| After re-heating | 4700 |
| 3 months after UHT-treatment | |
| Before re-heating | 4000 |
| After re-heating | 4300 |

These products already have developed viscosity during UHT-treatment and afterwards during second heating there is further increase of viscosity.

1. A UHT-treated product comprising a stabilized starch n-alkenyl succinate as a texturizing agent and wherein, after UHT-treatment, said UHT-treated product has a viscosity which is between 0.10 to 0.50 times the viscosity obtainable after re-heating of said UHT-treated product.

2. A UHT-treated product according to claim 1, wherein, after UHT-treatment, said UHT-treated product has a viscosity which is between 0.15 to 0.40 times the viscosity obtainable after re-heating of said UHT-treated product.

3. A UHT-treated product according to claim 1 or 2, wherein the stabilized n-alkenyl succinate is a C₆ to C₁₆ n-alkenyl succinate.

4. UHT-treated product according to claim 1 or 2, wherein said UHT-treated product includes at least one starch alkenyl succinate that is undextrinised, dextrinised, cooked-up, pregelatinised, or enzyme-treated.

5. A UHT-treated product according to claim 4, wherein in said product said viscosity is between 0.15 to 0.35 times the viscosity obtainable after re-heating of said UHT-treated product.

6. A UHT-treated product according to claim 1 or 2, wherein said product is selected from the group consisting of UHT-treated sauces, soups, liquid desserts, dressings and fillings.

7. A UHT-treated white sauce according to claim 6, wherein:
a) it comprises from 2 to 5% w/w stabilized starch n-alkenyl succinate,
b) a viscosity after UHT treatment of below 1500 mPa.s,
c) a viscosity after re-heating that increases to above 2000 mPa.s.

8. A process for preparing UHT-treated product comprising starch n-alkenyl succinate in which said process comprises:
a) preparing a mix of the ingredients that includes a stabilized starch n-alkenyl succinate,
b) preheating said mix to a temperature higher than 50° C.,
c) homogenizing said preheated mix at a pressure higher than 20 bar,
d) treating the mix by UHT at a temperature higher than 120° C., and
e) cooling the UHT-treated product.

9. A process according to claim 8, wherein said stabilized starch n-alkenyl succinate is a stabilized starch C₆-C₁₆ alkenyl succinate.

10. A process according to claim 8 or 9, wherein the UHT-treated product of step e) is re-heated to a temperature higher than 80° C.

11. A process for texturizing a UHT-treated product by incorporating therein a stabilized n-alkenyl succinate.

12. (canceled)

13. A method according to claim 11, wherein the viscosity of UHT-treated product is between 0.10 to 0.50 times the viscosity obtainable after re-heating of the UHT-treated product.

14. A process according to claim 11, wherein further processing said UHT-treated product to a sauce, soup, liquid dessert, dressing or filling.

15. A process according to claim 11, wherein said UHT-treated product has an egg yolk content wherein said egg yolk content is reduced by at least 50% by adding said stabilized starch alkenyl succinate, in comparison to the UHT-treated product lacking said stabilized starch alkenyl succinate.

16. A UHT-treated product according to claim 1, wherein said stabilized n-alkenyl succinate is a stabilized n-octenyl succinate.

17. A UHT-treated white source according to claim 7, wherein said white source contains from 3 to 4% w/w of said stabilized n-alkenyl succinate.

18. A UHT-treated white sauce according to claim 7, wherein said viscosity after UHT-treatment is below 1000 mPas.

19. A process according to claim 8, where in b) the temperature is a temperature up to 75° C.

20. A process according to claim 8, wherein the UHT-treated product of e) is re-heated to a temperature higher than 90° C.

21. A UHT-treated product according to claim 1, wherein said UHT-treated product is between 0.15 to 0.35 times the viscosity of a re-heated UHT-treated product.
